(19) United States
(12) Patent Application Publication
(10) Pub. No.: US 2026/0160245 A1
(43) Pub. Date: Jun. 11, 2026

(54) BUILT-IN TYPE EXTRACTING AND BLOWING INTEGRATED BLOWER

(71) Applicant: Shenzhen Smartnewo Technology Co., Ltd, Shenzhen (CN)

(72) Inventors: Dezhong WU, Shenzhen (CN); Hui PAN, Shenzhen (CN); Jianzhong XU, Shenzhen (CN)

(73) Assignee: Shenzhen Smartnewo Technology Co., Ltd, Shenzhen (CN)

(21) Appl. No.: 19/537,582

(22) Filed: Feb. 12, 2026

Related U.S. Application Data
(63) Continuation of application No. PCT/CN2023/129684, filed on Nov. 3, 2023.

(30) Foreign Application Priority Data
Sep. 15, 2023 (CN) 2023112032892

(51) Int. Cl. F04B 53/10; F04B 35/04; F04B 53/16

(52) U.S. Cl. CPC F04B 53/102; F04B 53/16; F04B 35/04

(57) ABSTRACT

The present application relates to a built-in type extracting and blowing integrated blower, comprising an air pump, a lead screw, a drive motor, valve heads, and a housing. The air pump is provided with an air blowing port and an air extracting port each provided with a blocking portion, and the housing is correspondingly provided with an air blowing hole and an air extracting hole. When the air pump is moved to the air blowing valve head, the blocking portion of the air blowing port abuts against the valve head to open the air blowing hole, so as to achieve air blowing; when the air pump is moved to the air extracting valve head, the blocking portion of the air extracting port opens the air extracting hole to achieve air extracting. The structure does not require manual switching and is easy to operate.

### CROSS-REFERENCE TO RELATED APPLICATIONS

The application claims priority to Chinese patent application No. 2023112032892, filed on Sep. 15, 2023, the entire contents of which are incorporated herein by reference.

### TECHNICAL FIELD

The present application relates to the field of air inflatable articles, and more particularly relates to a built-in type extracting and blowing integrated blower.

### BACKGROUND

In order to improve sleep quality or improve life comfort, more and more consumers choose to buy inflatable products as mattresses, seat cushions, recliners, etc., and many automotive manufacturers also provide inflatable facilities such as air bed inside vehicles in order to improve comfort inside vehicles.

Blowers serve as core components of various inflatable products to achieve the effects of inflating an inflatable product and extracting air from the inflated product. Conventional blowers require the user to manually switch the air pump between air blowing and air extracting modes, causing the user to have inconvenience in operation.

### SUMMARY

The present application provides a built-in type extracting and blowing integrated blower to solve the technical problem that the conventional blowers require a user to manually switch between air extracting and air blowing, which causes inconvenience in operation.

In order to solve the above technical problems, one technical solution adopted in the present application is to provide a built-in type extracting and blowing integrated blower, the built-in type extracting and blowing integrated blower includes an air pump, a lead screw, a drive motor, valve heads, and a housing,
the air pump includes an air blowing port and an air extracting port, and the air blowing port and the air extracting port are each provided with a blocking portion;
the lead screw is horizontally disposed, and the air pump and the lead screw are slidably assembled;
the drive motor is used for driving the air pump to move laterally along the lead screw;
the valve heads include an air blowing valve head and an air extracting valve head, or the air blowing valve head and/or the air extracting valve head are replaced with one-way valves;
the housing includes an air blowing hole and an air extracting hole, the air blowing hole and the air extracting hole are disposed at two sides of the housing, the air pump is disposed inside the housing, and the valve heads are respectively disposed at positions of the air blowing hole and the air extracting hole,
where in a process that the air pump is driven by the drive motor to move along the lead screw towards the air blowing valve head, the blocking portion at the position of the air blowing port directly abuts against the air blowing valve head to open the air blowing hole, or a one-way air valve is disposed at the air blowing hole, so that the air pump can blow air to the outside through the air blowing hole;
in a process that the air pump is driven by the drive motor to move along the lead screw towards the air extracting valve head, the blocking portion at the position of the air extracting port directly abuts against the air extracting valve head to open the air extracting hole, or a one-way air valve is disposed at the air extracting hole, so that the air pump can extract air from the outside through the air extracting hole.

In a specific embodiment of the present application, the air blowing port, the air extracting port, the blocking portions, the valve heads, the air blowing hole, and the air extracting hole are all disposed at the same horizontal height.

In a specific embodiment of the present application, the air blowing valve head and the air extracting valve head have the same structure and each include a mounting portion, a spring, a rubber stopper, and a choke stopper, and the air blowing valve head and the air extracting valve head are fixedly assembled on two sides of the housing through the mounting portions, or the air blowing valve head and/or the air extracting valve head are replaced with one-way air valves.

In a specific embodiment of the present application, the choke stopper includes a choke plate, the rubber stopper and the choke plate are tightly combined, the rubber stopper and the choke plate have the same shape and both match the air blowing hole and the air extracting hole in shape, and the rubber stopper and the choke plate are used for blocking the air blowing hole and the air extracting hole.

In a specific embodiment of the present disclosure, the housing further includes sleeves, the sleeves are disposed at the positions of the air blowing hole and the air extracting hole, the sleeves each include a first limiting surface, and the first limiting surfaces are used for limiting extreme positions of movement of the air pump.

In a specific embodiment of the present application, the built-in type extracting and blowing integrated blower further includes a reduction gear set, the drive motor drives the air pump to move laterally through the reduction gear set, and the reduction gear set is used for reducing a transmission speed of the drive motor.

In a specific embodiment of the present application, the built-in type extracting and blowing integrated blower further includes a cover body, the housing is provided with a first opening, a shape of the cover body is matched with a shape of the first opening, the cover body is fixedly assembled at the first opening of the housing, and the air pump is disposed within a space enclosed by the cover body and the housing.

In a specific embodiment of the present application, a surface of the cover body is provided with venting grooves, and air freely enters and exits from the space enclosed by the cover body and the housing through the venting grooves.

In a specific embodiment of the present application, the cover body is provided with fixed teeth, the fixed teeth and a reduction gear set are subjected to gear assembling, and when the drive motor drives the reduction gear set to rotate, the reduction gear set moves relative to the fixed teeth, thereby driving the air pump connected to the reduction gear set to move.

In a specific embodiment of the present application, the built-in type extracting and blowing integrated blower further has a bluetooth function, and a user can operate the built-in type extracting and blowing integrated blower to perform air blowing and air extracting through a bluetooth device connected to the built-in type extracting and blowing integrated blower.

The beneficial effects of the present application are as follows: in the process that the air pump is driven by the drive motor to move along the lead screw towards the air blowing valve head, the blocking portion at a position of the air blowing port abuts against the air blowing valve head to open the air blowing hole, such that the air pump can blow air to an outside through the air blowing hole; in the process that the air pump is driven by the drive motor to move along the lead screw towards the air extracting valve head, the blocking portion at a position of the air extracting port abuts against the air extracting valve head to open the air extracting hole, so that the air pump can extract air from the outside through the air extracting hole, and the problem that inconvenient operation is caused by manual switching of a conventional blower between air extracting and air blowing modes is solved.

### BRIEF DESCRIPTION OF THE DRAWINGS

To describe the technical solutions in embodiments of the present application more clearly, the following briefly describes the accompanying drawings required for describing the embodiments. Apparently, the accompanying drawings in the following description show merely some embodiments of the present application, and a person of ordinary skill in the art may still derive other drawings from these accompanying drawings without creative efforts. In the figures:

FIG. 1 is a three-dimensional structural schematic diagram of a built-in type extracting and blowing integrated blower according to an embodiment of the present application;

FIG. 2 is an exploded view of the built-in type extracting and blowing integrated blower shown in FIG. 1;

FIG. 3 is a three-dimensional structural schematic diagram of an air pump, reduction gear set and drive motor portion;

FIG. 4 is a three-dimensional structural schematic diagram of a cover body portion in the built-in type extracting and blowing integrated blower shown in FIG. 1;

FIG. 5 is a three-dimensional structural schematic diagram of the cover body portion shown in FIG. 4 from another perspective;

FIG. 6 is a three-dimensional structural schematic diagram of a housing portion in the built-in type extracting and blowing integrated blower shown in FIG. 1;

FIG. 7 is a three-dimensional structural schematic diagram of the housing portion shown in FIG. 6 from another perspective;

FIG. 8 is a three-dimensional structural schematic diagram of a reduction gear set and a drive motor in the built-in type extracting and blowing integrated blower shown in FIG. 1;

FIG. 9 is a three-dimensional structural schematic diagram of a first fixing plate, second fixing plate and lead screw portion in the built-in type extracting and blowing integrated blower shown in FIG. 1;

FIG. 10 is a three-dimensional structural schematic diagram of an assembly housing portion in the built-in type extracting and blowing integrated blower shown in FIG. 1;

FIG. 11 is a three-dimensional structural schematic diagram of the assembly housing portion shown in FIG. 10 from another perspective; and

FIG. 12 is a three-dimensional structural schematic diagram of an air blowing valve head portion in the built-in type extracting and blowing integrated blower shown in FIG. 1.

Reference numerals: 10, built-in type extracting and blowing integrated blower; 100, air pump; 110, air blowing port; 120, air extracting port; 130, blocking portion; 131, rectangular connecting plate; 132, tapered abutting portion; 140, sliding matching portion; 141, sliding assembly hole; 150, first accommodating groove; 151, fourth positioning hole; 160, fourth positioning column; 170, fifth positioning column; 200, lead screw; 210, first fixing plate; 211, assembly groove; 220, second fixing plate; 230, fifth assembly through hole; 240, mounting hole; 250, semi-circular notch; 300, drive motor; 310, second assembly through hole; 320, drive gear; 400, housing; 410, air blowing hole; 420, air extracting hole; 430, first opening; 440, first side wall; 450, second side wall; 460, third side wall; 470, fourth side wall; 480, fifth side wall; 490, first convex wall; 500, boss; 510, first positioning column; 511, first positioning hole; 512, first fixing block; 520, second positioning column; 521, second positioning hole; 522, second fixing block; 530, sleeve; 531, second convex wall; 532, first limiting surface; 540, seventh positioning column; 600, cover body; 610, cover plate; 620, gear matching portion; 621, rectangular wall; 622, arc-shaped wall; 623, second opening; 624, fixed tooth; 630, ring wall; 640, first assembly through hole; 650, venting groove; 651, separation block; 660, through groove; 700, reduction gear set; 710, first gear; 720, second gear; 730, fixed shaft; 740, displacement gear; 741, cylindrical portion; 742, gear portion; 743, limiting cap; 750, first transmission gear portion; 760, second transmission gear portion; 770, third transmission gear portion; 780, fourth transmission gear portion; 790, fifth transmission gear portion; 800, assembly housing; 810, motor accommodating groove; 820, third assembly through hole; 830, first circular through hole; 840, gear accommodating groove; 841, third positioning column; 842, third positioning hole; 850, rectangular fixing plate; 860, gear accommodating hole; 870, fourth assembly through hole; 900, plug-in module; 1000, air blowing valve head; 1100, mounting portion; 1110, sixth positioning column; 1120, trapezoidal connecting plate; 1130, assembly cylinder; 1131, separation cylinder; 1140, circular limiting surface; 1200, spring; 1300, rubber stopper; 1400, choke stopper; 1410, choke plate; 1420, abutting shaft; 1430, assembly shaft; 2000, air extracting valve head.

### DETAILED DESCRIPTION OF THE EMBODIMENTS

The technical solutions in the embodiments of the present application will be clearly and completely described below with reference to the accompanying drawings in the embodiments of the present application. Apparently, the described embodiments are only some rather than all of the embodiments of the present application. All other embodiments obtained by a person of ordinary skill in the art based on the embodiments of the present application without creative efforts shall fall within the protection scope of the present application.

It should be noted that, if there are directional indications (such as up, down, left, right, front, back, . . . ) in embodiments of the present application, the directional indications in the embodiments of the present disclosure are only intended for explaining a relative position relationship, a movement condition, etc., between components in a certain posture (as shown in the figures), and if the posture changes, the directional indications change accordingly.

In addition, if there are descriptions relating to “first”, “second”, etc. in the embodiments of the present application, the descriptions relating to “first”, “second”, etc. in the present application are merely intended for descriptive purposes and should not be construed as indicating or implying their relative importance or implying the quantity of technical features indicated. Therefore, a feature limited by “first” or “second” may explicitly or implicitly include at least one of such features. In addition, the technical solutions of various embodiments may be combined with each other, but they must be based on the ability of those of ordinary skill in the art to implement, when the combination of technical solutions contradicts each other or cannot be implemented, it should be considered that the combination of technical solutions does not exist and is not within the scope of protection claimed in the present application.

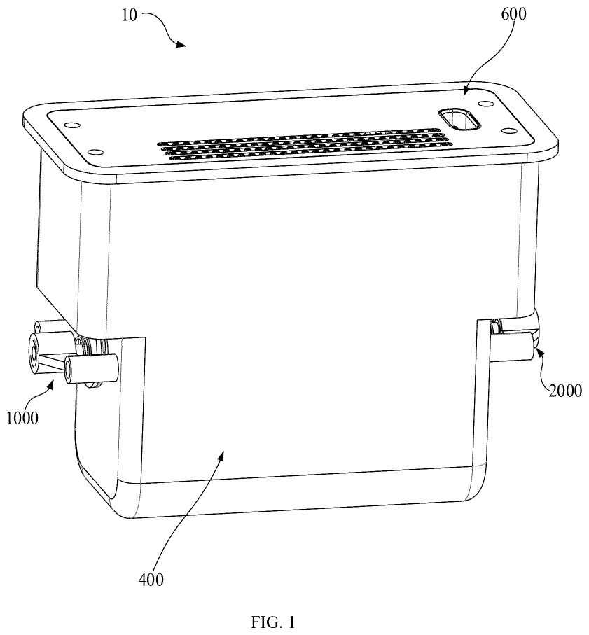

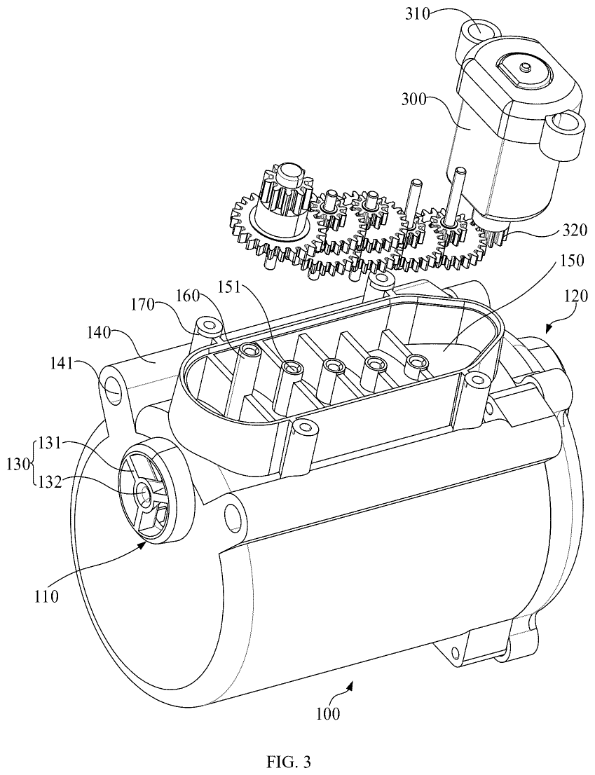

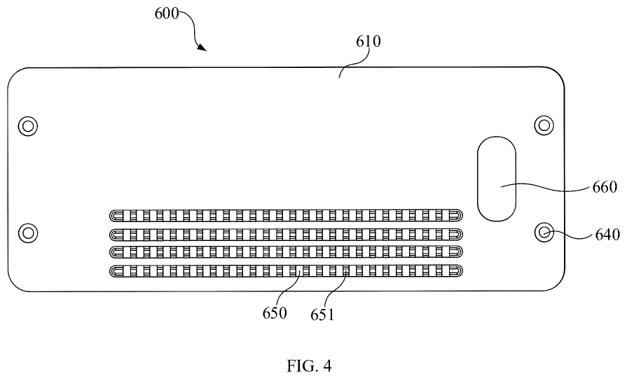

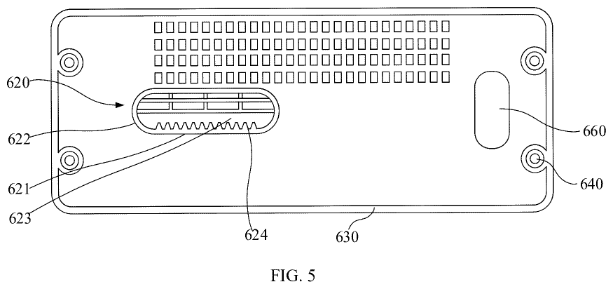

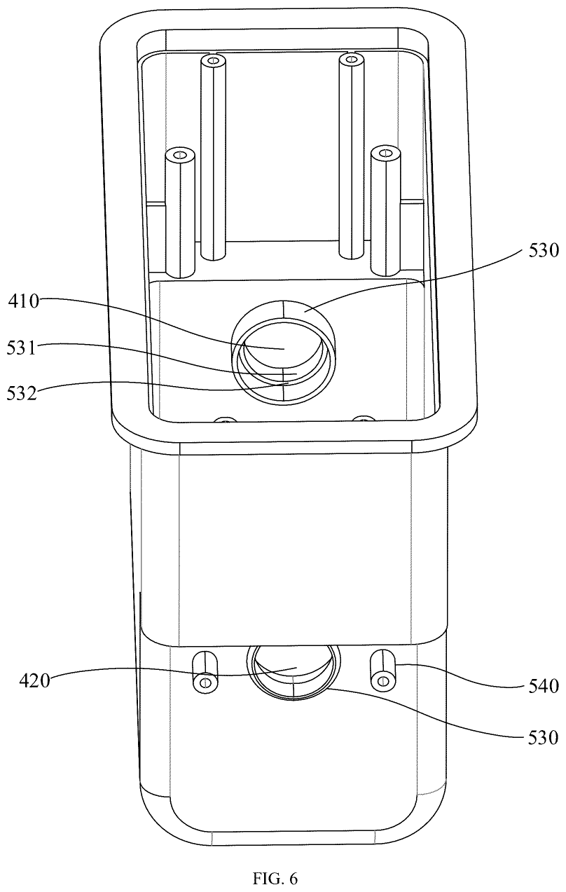

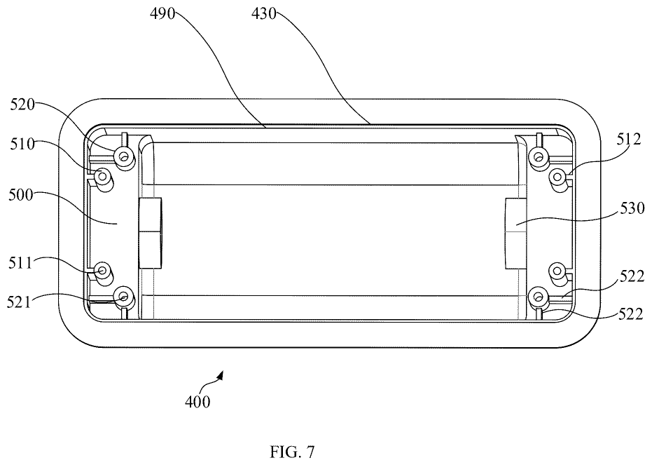

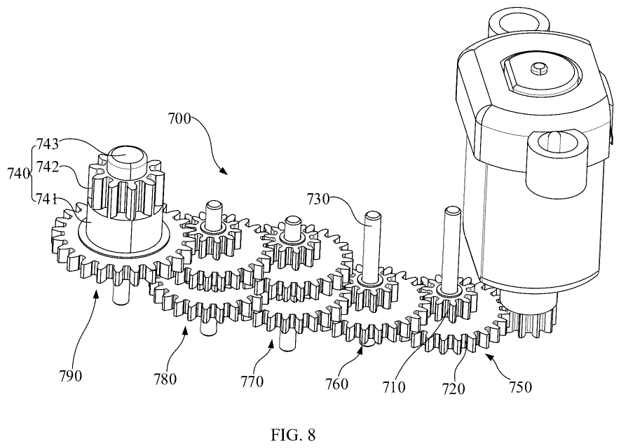

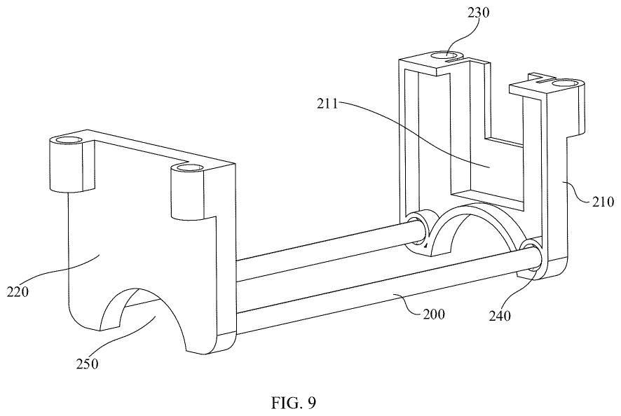

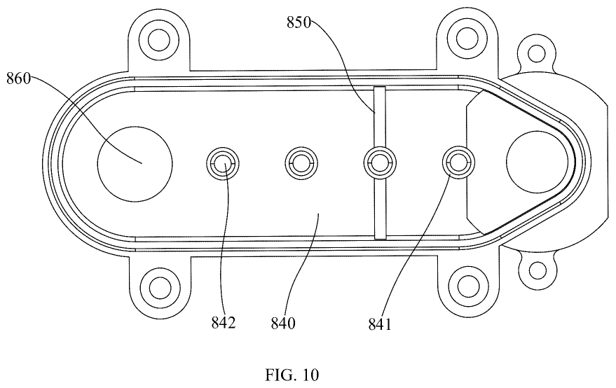

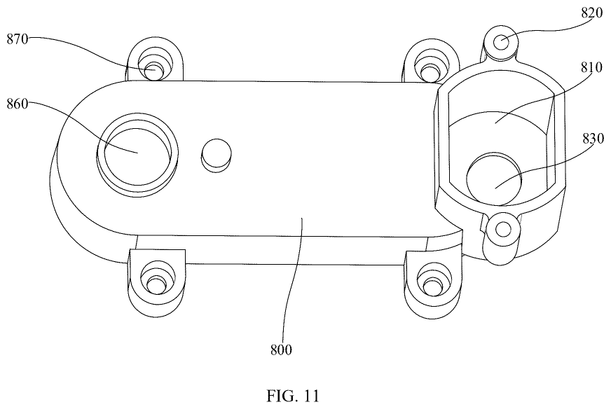

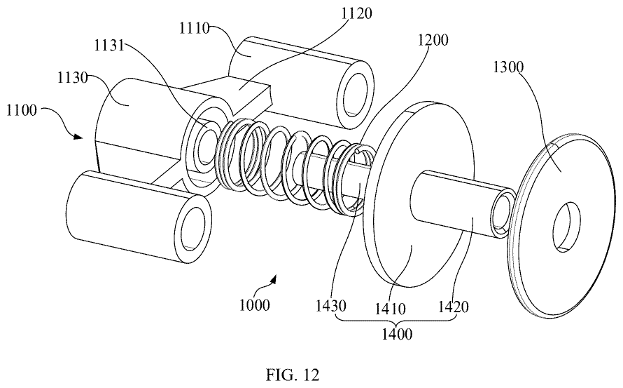

As shown in FIG. 1 to FIG. 12, an embodiment of the present application discloses a built-in type extracting and blowing integrated blower 10, the built-in type extracting and blowing integrated blower 10 includes an air pump 100, a lead screw 200, a drive motor 300, valve heads, and a housing 400; the air pump 100 includes an air blowing port 110 and an air extracting port 120, the air blowing port 110 and the air extracting port 120 are each provided with a blocking portion 130, the lead screw 200 is horizontally disposed, the air pump 100 and the lead screw 200 are slidably assembled, the drive motor 300 is used for driving the air pump 100 to move laterally along the lead screw 200, the valve head includes an air blowing valve head 1000 and an air extracting valve head 2000, the housing 400 includes an air blowing hole 410 and an air extracting hole 420, the air blowing hole 410 and the air extracting hole 420 are disposed at two sides of the housing 400, the air pump 100 is disposed inside the housing 400, and the valve heads are disposed at the positions of the air blowing hole 410 and the air extracting hole 420, respectively. In actual use, the air extracting hole 420 and the air blowing hole 410 in the built-in type extracting and blowing integrated blower 10 need to be placed inside an inflatable article while the cover body 600 needs to be exposed outside the inflatable article,
where in processes that the air pump 100 is driven by the drive motor 300 and moves along the lead screw 200 to move towards the air blowing valve head 1000, the blocking portion 130 at the position of the air blowing port 110 directly abuts against the air blowing valve head 1000 to open the air blowing hole 410, so that the air pump 100 can blow air to the outside through the air blowing hole 410.

In processes that the air pump 100 is driven by the drive motor 300 and moves along the lead screw 200 towards the air extracting valve head 2000, the blocking portion 130 at the position of the air extracting port 120 directly abuts against the air extracting valve head 2000 to open the air extracting hole 420, so that the air pump 100 can extract air from the outside through the air extracting hole 420.

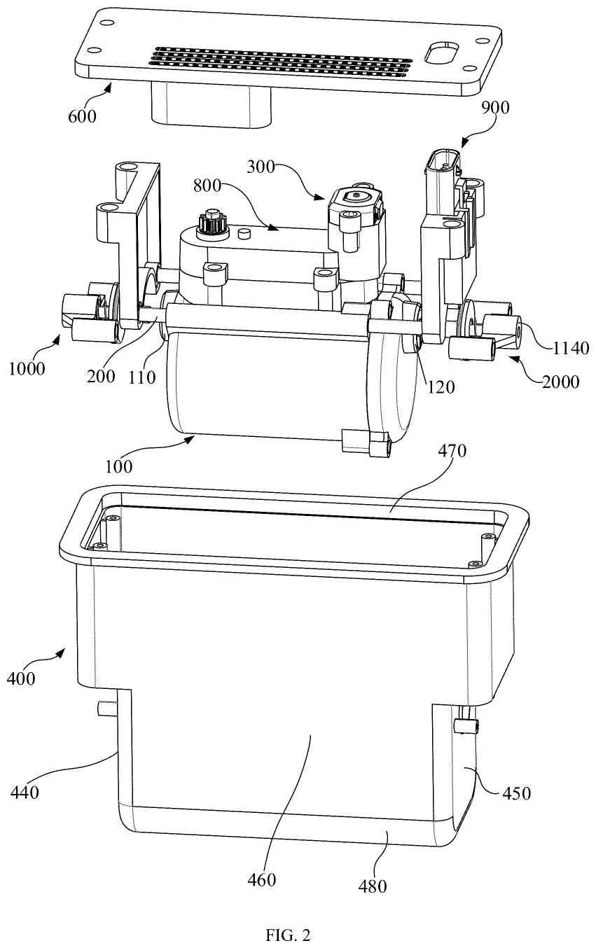

According to the housing 400 shown in the perspective of FIG. 2, the housing 400 is a container having a first opening 430 on one surface, the first opening 430 is substantially rectangular in shape, the shape of the first opening 430 is not fixed and can also be other shapes, the housing 400 is used for accommodating various other components of the built-in type extracting and blowing integrated blower 10, the housing 400 is formed by five side walls in an enclosing manner, the left and right sides of the housing 400 are a first side wall 440 and a second side wall 450, respectively, the front and rear sides of the housing 400 are a third side wall 460 and a fourth side wall 470, respectively, a fifth side wall 480 is disposed at the lower end of the housing 400, and various adjacent side walls are bent and connected. A first convex wall 490 is disposed at one end of an inner surface of the housing 400 adjacent to the first opening 430, an upper surface of the first convex wall 490 is lower than a plane where the first opening 430 is located, and the first convex wall 490 surrounds an inner surface of the housing 400. Outwardly expanded bosses 500 are disposed on two sides of an inside of the housing 400 near the first side wall 440 and the second side wall 450, the bosses 500 on the two sides are the same in shape and size, four positioning columns are disposed on the boss 500 on each side, the four positioning columns are two first positioning columns 510 and two second positioning columns 520, respectively, the first positioning columns 510 are cylindrical, the first positioning columns 510 disposed on the bosses 500 on the two sides are vertically disposed on the upper surfaces of the bosses 500 and are near one end of the first side wall 440 and one end of the second side wall 450, respectively, first positioning holes 511 are disposed at central positions of the first positioning columns 510, the first positioning holes 511 are circular, first fixing blocks 512 are disposed between the first positioning columns 510 and the first side wall 440 and the second side wall 450, respectively, the first fixing blocks are rectangular, the first fixing blocks 512 are perpendicular to upper surfaces of the bosses 500, the first fixing blocks 512 connect the first positioning columns 510 with the first convex wall 490, heights of the first fixing blocks 512 are substantially equal to heights of the first positioning columns 510, and the first fixing blocks 512 are used for maintaining the first positioning columns 510 stable. The second positioning columns 520 are cylindrical, diameters of the second positioning columns 520 are slightly larger than those of the first positioning columns 510, lengths of the second positioning columns 520 are less than lengths of the first positioning columns 510, the second positioning columns 520 are vertically disposed on one side of the upper surface of each of the two bosses 500 adjacent to the third side wall 460 and the fourth side wall 470, respectively, second positioning holes 521 are disposed at central positions of the second positioning columns 520, the second positioning holes 521 are circular, second fixing blocks 522 are disposed between the second positioning columns 520 and the first convex wall 490, the second fixing blocks 522 are rectangular, heights of the second fixing blocks 522 are smaller than heights of the second positioning columns 520, the second fixing blocks 522 are vertically disposed on the upper surfaces of the bosses 500, each second positioning column 520 is connected to two second fixing blocks 522, the two second fixing blocks 522 form an angle of 90 degrees, the second fixing blocks 522 are used for maintaining the second positioning columns 520 stable, and various structures in the housing 400 are integrally formed with the housing 400.

The air extracting hole 420 and the air blowing hole 410 are disposed at the lower ends of the first side wall 440 and the second side wall 450 of the housing 400, respectively, the air extracting hole 420 and the air blowing hole 410 are each a circular through hole penetrating the side wall of the housing 400, the air extracting hole 420 and the air blowing hole 410 are each disposed below the bosses 500, centers of circle of the air extracting hole 420 and the air blowing hole 410 are located at the same horizontal height, sleeves 530 are disposed in the air extracting hole 420 and the air blowing hole 410, the sleeves 530 are cylindrical, the sleeves 530 match the air extracting hole 420 and the air blowing hole 410 in shape, the sleeves 530 are fixedly assembled with the air extracting hole 420 and the air blowing hole 410, the sleeves 530 protrude toward the inside of the housing 400 to be out of the first side wall 440 and the second side wall 450, the inner walls of the sleeves 530 are provided with second convex walls 531, the second convex walls 531 protrude out of the inner surfaces of the sleeves 530, and the second convex walls 531 and the sleeves 530 are integrally molded; the ends of the second convex walls 531 are provided with first limiting surfaces 532, the first limiting surfaces 532 are in a ring shape and are located at the middle portions of the sleeves 530.

The built-in type extracting and blowing integrated blower 10 further includes a cover body 600, the cover body 600 includes a cover plate 610 and a gear matching portion 620, the cover plate 610 is substantially rectangular, and a shape of the cover plate 610 is matched with a shape of the first opening 430, such that the cover plate 610 can block the first opening 430; a ring wall 630 is disposed at a circumference of the cover plate 610, a height of the ring wall 630 is substantially equal to a height from the upper surface of the first convex wall 490 to the plane where the first opening 430 is located, when the cover plate 610 penetrates the first opening 430 to fall on the upper surface of the first convex wall 490, a lower surface of the ring wall 630 around the cover plate 610 is in contact with the upper surface of the first convex wall 490, first assembly through holes 640 corresponding to the first positioning holes 511 are disposed on two sides of the cover plate 610, the number of the first assembly through holes 640 is four, and the four first assembly through holes 640 and the four first positioning holes 511 are in one-to-one correspondence; the cover body 600 and the housing 400 are fixedly assembled together by screws through the first assembly through holes 640 and the first positioning holes 511, venting grooves 650 are also disposed on the surface of the cover plate 610, the venting grooves 650 penetrate the cover plate 610 in a thickness direction, the venting grooves 650 are elongated, the number of venting grooves 650 is multiple, the plurality of venting grooves 650 are disposed at intervals in parallel, separation blocks 651 are disposed in the venting grooves 650, the separation blocks 651 are in a “convex” shape, a plurality of separation blocks 651 disposed at equal intervals are disposed in each venting groove 650 to prevent foreign matter from entering the inside of the housing 400 from venting grooves 650, and the shapes and positions of the venting grooves 650 can be changed according to actual needs.

The gear matching portion 620 is formed by two rectangular walls 621 having the same shape and two arc-shaped walls 622 having the same shape in an enclosing manner, the upper end of the gear matching portion 620 and the lower surface of the cover plate 610 are fixedly assembled, the lower end of the gear matching portion 620 is provided with a second opening 623, fixed teeth 624 are further disposed on inner surfaces of the rectangular walls 621 in the gear matching portion 620, the fixed teeth 624 are vertically disposed, the built-in type extracting and blowing integrated blower 10 further includes a reduction gear set 700, and a tooth profile of the fixed teeth 624 can be matched with a tooth profile of the reduction gear set 700.

The drive motor 300 is disposed vertically, second assembly through holes 310 are disposed on two sides of the drive motor 300 adjacent to the third side wall 460 and the fourth side wall 470, respectively, a drive gear 320 is disposed at the lower end of the drive motor 300, the drive motor 300 is far away from the gear matching portion 620, the reduction gear set 700 is disposed between the drive motor 300 and the gear matching portion 620, the reduction gear set 700 connects the drive gear 320 with the fixed teeth 624 through gear assembling, the reduction gear set 700 includes a plurality of first gears 710, a plurality of second gears 720, a plurality of fixed shafts 730, and a displacement gear 740, the first gears 710 and the second gears 720 are the same in shape and structure and are circular, diameters of the first gears 710 are smaller than diameters of the second gears 720, the fixed shafts 730 are cylindrical, fixing through holes are disposed at positions of the centers of circle of the first gears 710 and the second gears 720, the fixing through holes are circular, diameters of the fixing through holes are matched with diameters of the fixed shaft 730, the displacement gear 740 is cylindrical as a whole, the displacement gear 740 includes a cylindrical portion 741 and a gear portion 742, the cylindrical portion 741 is disposed at a lower end of the gear portion 742, a tooth profile of the gear portion 742 is matched with a tooth profile of the fixed teeth 624, the gear portion 742 is in contact with the fixed teeth, the center of the displacement gear 740 is provided with a fixing through hole the same as those of the first gears 710, a limiting cap 743 is disposed at an upper end of the displacement gear 740, a shape of the limiting cap 743 is matched with a shape of the fixed shaft 730, the limiting cap 743 is disposed at the fixing through hole of the displacement gear 740, and the limiting cap 743 is used for preventing the fixed shaft 730 from moving vertically.

The reduction gear may be divided into five transmission gear portions that are laterally connected, where the first transmission gear portion 750 is disposed on a side of the drive motor 300 adjacent to the gear matching portion 620, the first transmission gear portion 750 includes one first gear 710, one second gear 720, and one fixed shaft 730, the fixed shaft 730 is disposed vertically, the first gear 710 and the second gear 720 are horizontally disposed, the first gear 710 is fixedly assembled to the upper surface of the second gear 720, and the two gears are concentric; the fixed shaft 730 penetrates the fixing through holes of the first gear 710 and the second gear 720 and are fixedly assembled with the two gears, and the second gear 720 in the first transmission gear portion 750 is connected to the drive gear 320 of the drive motor 300.

A second transmission gear portion 760 is disposed on a side of the first transmission gear portion 750 adjacent to the gear matching portion 620, the second transmission gear portion 760 is the same as the first transmission gear portion 750 in structure, and a second gear 720 in the second transmission gear portion 760 is connected to the first gears 710 in the first transmission gear portion 750.

A third transmission gear portion 770 is disposed on a side of the second transmission gear portion 760 adjacent to the gear matching portion 620, the third transmission gear portion 770 includes a first gear 710, a second gear 720, a first gear 710, a second gear 720, and a vertically disposed fixed shaft 730 which are horizontally disposed in sequence from top to bottom, various gears mentioned above are fixedly assembled together in a concentric manner, the fixed shaft 730 penetrates fixing through holes of various gears and is fixedly assembled with various gears, and the fourth gear from top to bottom in the third gear transmission part is connected to the first gear 710 in the second gear transmission portion 720.

A fourth transmission gear portion 780 is disposed on a side of the third transmission gear portion 770 adjacent to the gear matching portion 620, the fourth transmission gear portion 780 has the same structure as the third transmission gear portion 770, and two second gears 720 in the fourth transmission gear portion 780 are connected to the two first gears 710 in the third transmission gear portion 770.

A fifth transmission gear portion 790 is disposed on a side of the fourth transmission gear portion 780 adjacent to the gear matching portion 620, the fifth transmission gear portion 790 includes one second gear 720, one displacement gear 740, and one fixed shaft 730, the second gear 720 and the displacement gear 740 are horizontally disposed, the displacement gear 740 is fixedly assembled on the upper surface of the second gear 720 and concentrically disposed with the second gear 720, the fixed shaft 730 vertically penetrates the fixing through holes of the displacement gear 740 and the second gear 720 and is fixedly assembled with the two gears, and the fixed shafts 730 in the five transmission gear portions are located in the same plane.

The built-in type extracting and blowing integrated blower 10 further includes an assembly housing 800, the assembly housing 800 is irregular in shape, an end of the assembly housing 800 is provided with a motor accommodating groove 810 matched with the drive motor 300, third assembly through holes 820 matched with the second assembly through holes 310 on two sides of the drive motor 300 are disposed on two sides of the motor accommodating groove 810, the screws fixedly assemble the drive motor 300 into the motor accommodating groove 810 through the second assembly through holes 310 and the third assembly through holes 820, a first circular through hole 830 for passing through the drive gear 320 is disposed in the motor accommodating groove 810, a lower surface of the assembly housing 800 is further provided with a gear accommodating groove 840, the gear accommodating groove 840 is irregular in shape, the upper end of the reduction gear set 700 is placed inside the gear accommodating groove 840, four cylindrical third positioning columns 841 arranged in a straight line are disposed at the symmetry axis positions of the gear accommodating groove 840, central positions of the four third positioning columns 841 are each provided with a third positioning hole 842, the third positioning holes 842 are circular, diameters of the third positioning holes 842 are matched with diameters of the fixed shafts 730, the upper ends of the fixed shafts 730 and the third positioning holes 842 are rotationally assembled, in the four third positioning columns 841, from the third positioning column 841 away from the motor accommodating groove 810 to the third positioning column 841 close to the motor accommodating groove 810, lengths of the third positioning columns 841 increase in sequence, rectangular fixing plates 850 are disposed on two sides of the third positioning column 841 corresponding to the second transmission gear portion 760 for fixing the third positioning columns 841, and the third positioning column 841 corresponding to the first transmission gear portion 750 is disposed next to an inside the motor accommodating groove 810. A gear accommodating hole 860 is further disposed at an end inside the gear accommodating groove 840 that is away from the motor accommodating groove 810, the gear accommodating hole 860 is matched with the fifth transmission gear portion 790, and an upper end of the displacement gear 740 in the fifth transmission gear portion 790 penetrates the gear accommodating hole 860 to be connected to the fixed teeth 624 on the cover body 600.

The air pump 100 is substantially cylindrical, the air pump 100 is horizontally disposed below the reduction gear set 700, a first accommodating groove 150 is further disposed at an upper end of the air pump 100, the fixed shaft 730 and the drive motor 300 are vertically disposed between the assembly housing 800 and the first accommodating groove 150, a shape of the first accommodating groove 150 is matched with a shape of the assembly housing 800, fourth positioning columns 160 corresponding to the third positioning columns 841 are disposed on the symmetry axis of the first accommodating groove 150, the fourth positioning columns 160 are cylindrical and are vertically disposed inside the first accommodating groove 150, central positions of the fourth positioning columns 160 are provided with fourth positioning holes 151, the fourth positioning holes 151 are circular, and diameters of the fourth positioning holes 151 are matched with the diameters of the fixed shafts 730; the lower ends of the fixed shafts 730 and the fourth positioning holes 151 are rotatably assembled, there are five fourth positioning columns 160, and in the five fourth positioning columns 160, from the fourth positioning column 160 close to the drive motor 300 to the fourth positioning column 160 far from the drive motor 300, lengths of the fourth positioning columns 160 increase in sequence. Four fifth positioning columns 170 in rectangular distribution are disposed on two sides of the first accommodating groove 150, threaded holes are disposed at central positions of the fifth positioning columns 170, corresponding fourth assembling through holes 870 are disposed on two sides of the assembly housing 800, and screws fixedly assemble the assembly housing 800 and the first accommodating groove 150 through the fourth assembling through holes 870 and the threaded holes. Sliding matching portions 140 are further disposed on two sides of the upper end of the air pump 100, the sliding matching portions 140 are horizontally disposed, the sliding matching portions 140 are substantially cylindrical, the sliding matching portions 140 on two sides are located at the same horizontal height, the sliding matching portions 140 include sliding assembly holes 141, the sliding assembly holes 141 transversely penetrate the sliding matching portions 140, shapes of the sliding matching portions 141 are matched with shapes of the lead screws 200, the lead screws 200 are cylindrical, and the lead screws 200 horizontally penetrate the sliding assembly portions and are slidably assembled with the sliding assembly holes 141. When the drive motor 300 drives the reduction gear set 700 to rotate, after a series of transmission of the gears in the reduction gear set 700, a rotation speed of the displacement gear 740 is smaller than a rotation speed of the drive gear 320 of the drive motor 300. When the displacement gear 740 is rotated, the displacement gear 740 is moved laterally due to the restrained action of the fixed teeth 624, thereby driving the air pump 100 connected to the displacement gear 740 to move laterally along the lead screws.

A first fixing plate 210 and a second fixing plate 220 are further disposed at two ends of the lead screw 200, the first fixing plate 210 and the second fixing plate 220 are disposed vertically at an interval, upper ends of the first fixing plate 210 and the second fixing plate 220 are both provided with fifth assembly through holes 230 matched with the second positioning holes 521 of the housing 400, screws fixedly assemble the first fixing plate 210 and the second fixing plate 220 with the housing 400 through the fifth assembly through holes 230 and the second positioning holes 521, two sides of the lower ends of the first fixing plate 210 and the second fixing plate 220 are both provided with mounting holes 240 matched with the lead screws, and the lead screws 200 are fixed and fixedly assembled with the first fixing plate 210 and the second fixing plate 220 through the mounting holes 240, the lower ends of the first fixing plate 210 and the second fixing plate 220 are further provided with semi-circular notches 250, and the semi-circular notches 250 are used for portions of the sleeves 530 of the housing 400 to pass through.

The built-in type extracting and blowing integrated blower 10 further includes a plug-in module 900, the plug-in module 900 is disposed vertically, an upper end of the plug-in module 900 is provided with a plug-in connector, a through groove 660 matched with the plug-in module 900 in shape is disposed on the surface of the cover plate 610, the plug-in connector penetrates the through groove 660 to be externally connected with other devices, a bluetooth chip (not shown in the figure) is built in the plug-in module 900, the user can use a bluetooth device connected to the built-in type extracting and blowing integrated blower 10 to operate the built-in type extracting and blowing integrated blower 10 to perform air blowing and air extracting, an assembly groove 211 is disposed at a side of the first fixing plate 210 adjacent to the drive motor 300, a shape of the assembly groove 211 is matched with a shape of the plug-in module 900, and the plug-in module 900 is fixedly assembled with the first fixing plate 210 through the assembly groove 211.

The air blowing port 110 and the air extracting port 120 disposed on both left and right sides of the upper end of the air pump 100 are circular, the air pump 100 blows air to the outside of the air pump 100 or extracts air from the outside of the air pump 100 through the air blowing port 110 and the air extracting port 120, the blocking portions 130 are disposed inside the air blowing port 110 and the air extracting port 120, each of the blocking portions 130 includes three rectangular connecting plates 131 and one tapered abutting portion 132, the rectangular connecting plates 131 are uniformly distributed in the air blowing port 110 and the air extracting port 120, one end of each rectangular connecting plate 131 is connected with the inner walls of the air blowing port 110 and the air extracting port 120, and the other end of each rectangular connecting plate is connected with the tapered abutting portion 132, and the tapered abutting portion 132 is disposed at the central positions of the air blowing port 110 and the air extracting port 120.

The air blowing valve head 1000 and the air extracting valve head 2000 corresponding to the air blowing port 110 and the air extracting port 120 have the same structure, the air blowing valve head 1000 and the air extracting valve head 2000 each include a mounting portion 1100, a spring 1200, a rubber stopper 1300, and a choke stopper 1400, or the air blowing valve head 1000 and/or the air extracting valve head 2000 are replaced with one-way valves. The air blowing port 110, the air extracting port 120, the blocking portions 130, the valve heads, the air blowing hole 410, and the air extracting hole 420 are all disposed at the same horizontal height.

Each mounting portion 1100 includes a sixth positioning column 1110, a trapezoidal connecting plate 1120, and an assembly cylinder 1130, which are integrally formed, the sixth positioning columns 1110 are cylindrical, and the sixth positioning columns 1110 are horizontally disposed on two sides of the assembly cylinder 1130; the assembly cylinder 1130 is cylindrical and is horizontally disposed, and the centers of circle of the sixth positioning columns 1110 and the assembly cylinder 1130 are located on the same horizontal plane. Two trapezoidal connecting plates 1120 are horizontally disposed between the sixth positioning columns 1110 and the assembly cylinder 1130 for fixing the sixth positioning columns 1110 and the assembly cylinder 1130 together, sixth assembly through holes are disposed at the centers of the sixth positioning columns 1110, seventh positioning columns 540 corresponding to the sixth positioning columns 1110 are disposed on the outer surface of the housing 400, seventh assembly holes are disposed in the centers of the seventh positioning columns 540, the seventh positioning columns 540 can be inserted into the sixth assembly through holes, and then the sixth positioning columns 1110 and the seventh positioning columns 540 are fixedly assembled by screws, thereby fixing the mounting portions 1100 of the valve heads on the housing 400. A separation cylinder 1131 is further disposed in the assembly cylinder 1130, the separation cylinder 1131 is also cylindrical, a diameter of the separation cylinder 1131 is smaller than a diameter of the assembly cylinder 1130, and the separation cylinder 1131 and the assembly cylinder 1130 are concentrically disposed; the separation cylinder 1131 and the assembly cylinder 1130 are integrally formed at ends far from the choke stopper 1400 to form a circular limiting surface 1140, the spring 1200 is horizontally disposed, and a portion of the spring 1200 adjacent to the mounting portion 1100 is disposed in a space between an outer wall of the separation cylinder 1131 and an inner wall of the assembly cylinder 1130 and abuts against the circular limiting surface 1140; the choke stopper 1400 includes a choke plate 1410, and an end of the spring 1200 adjacent to the housing 400 abuts against the choke plate 1410.

The choke stopper 1400 includes a choke plate 1410, an abutting shaft 1420, and an assembly shaft 1430, which are integrally formed, the abutting shaft 1420 and the assembly shaft 1430 are both cylindrical and are horizontally connected, the abutting shaft 1420 is disposed at an end of the choke stopper 1400 adjacent to the blocking portion 130, the assembly shaft 1430 is disposed at an end of the choke stopper 1400 adjacent to the mounting portion 1100, a diameter of the abutting shaft 1420 is matched with a diameter of the tapered abutting portion 132, the diameter of the assembly shaft 1430 is matched with an inner diameter of the separation cylinder 1131, so that the assembly shaft 1430 can enter the separation cylinder 1131; the choke plate 1410 is disposed at a connection position of the abutting shaft 1420 and the assembly shaft 1430, the choke plate 1410 is circular, a shape of the choke plate 1410 is matched with the shapes of the air extracting hole 420 and the air blowing hole 410, and the diameter of the choke plate 1410 is larger than the diameters of the air extracting hole 420 and the air blowing hole 410. The rubber stopper 1300 has the same shape and size as the choke plate 1410, the rubber stopper 1300 and the choke plate 1410 are next to each other, the rubber stopper 1300 is disposed on a side of the choke plate 1410 close to the abutting shaft 1420, and the choke plate 1410 and the rubber stopper 1300 are used for blocking the air extracting port 120 and the air blowing port 110. In an actual working process, when it is desired to inflate the inflatable article, the air pump 100 moves along the lead screw 200 towards the air blowing hole 410, the tapered abutting portion 132 in the blocking portion 130 at the air blowing port 110 comes into contact with the abutting shaft 1420 in the air blowing valve head 1000 and pushes the abutting shaft 1420 horizontally away from the air blowing hole 410, such that the choke plate 1410 and the rubber stopper 1300 connected to the abutting shaft 1420 in the air blowing valve head 1000 are moved away from the air blowing hole 410, until the air blowing port 110 abuts against the first limiting surface 532 in the sleeve 530, the air pump 100 stops moving, then air is inflated into the inflatable article through the air blowing hole 110 and the air blowing hole 410, after the inflation is completed, the air pump 100 leaves the air blowing hole 410, the spring 1200 in the air blowing valve head 1000 pushes the choke plate 1410 and the rubber stopper 1300 back to the air blowing hole 410 again, and the choke plate 1410 and the rubber stopper 1300 again block the air blowing hole 410; extraction of air from the inflatable article is in the same principle as inflation into the inflatable article.

The above are all preferred embodiments of the present disclosure, and are not intended to limit the scope of protection of the present disclosure, so that equivalent variations according to the structure, shape, and principle of the present disclosure are intended to be included in the scope of protection of the present disclosure.

What is claimed is:

1. A built-in type extracting and blowing integrated blower (10), wherein the built-in type extracting and blowing integrated blower (10) comprises: an air pump (100) comprising an air blowing port (110) and an air extracting port (120), the air blowing port (110) and the air extracting port (120) being each provided with a blocking portion (130), and the air pump (100) being of a pump body structure movable laterally along a lead screw as a whole;
the lead screw (200) horizontally disposed, wherein the air pump (100) and the lead screw (200) are slidably assembled, the air pump (100) achieves lateral guidance by the lead screw (200), and the air blowing port (110), the air extracting port (120), the blocking portions (130), valve heads, the air blowing hole (410), and the air extracting hole (420) are all disposed at the same horizontal height;
a drive motor (300) in transmission connection with the air pump (100) through a reduction gear set (700) to convert rotational motion into lateral linear motion of the air pump (100), thereby driving the air pump (100) to move laterally along the lead screw (200);
the valve heads comprising an air blowing valve head (1000) and an air extracting valve head (2000), wherein the air blowing valve head (1000) and the air extracting valve head (2000) each comprise a mounting portion (1100), a spring (1200), a rubber stopper (1300), and a choke stopper (1400), and are fixedly assembled on two sides of the housing (400) through the mounting portions (1100);
a housing (400) comprising an air blowing hole (410) and an air extracting hole (420), wherein the air blowing hole (410) and the air extracting hole (420) are disposed on two sides of the housing (400), the air pump (100) is disposed inside the housing (400), the valve heads are respectively disposed at positions of the air blowing hole (410) and the air extracting hole (420), the housing (400) is provided with sleeves (530) at the positions of the air blowing hole (410) and the air extracting hole (420), the sleeves (530) each comprise a first limiting surface (532) to limit extreme positions of movement of the air pump (100),
wherein in processes that the air pump (100) is driven by the drive motor (300) and moves along the lead screw (200) towards the air blowing valve head (1000), the blocking portion (130) at the position of the air blowing port (110) directly abuts against the air blowing valve head (1000) to open the air blowing hole (410);
in processes that the air pump (100) is driven by the drive motor (300) and moves along the lead screw (200) towards the air extracting valve head (2000), the blocking portion (130) at the position of the air extracting port (120) directly abuts against the air extracting valve head (2000) to open the air extracting hole (420).

2. The built-in type extracting and blowing integrated blower (10) according to claim 1, wherein the choke stopper (1400) comprises a choke plate (1410), the rubber stopper (1300) and the choke plate (1410) are tightly combined, the rubber stopper (1300) and the choke plate (1410) have the same shape and both match the air blowing hole (410) and the air extracting hole (420) in shape, and the rubber stopper (1300) and the choke plate (1410) are used for blocking the air blowing hole (410) and the air extracting hole (420).

3. The built-in type extracting and blowing integrated blower (10) according to claim 1, wherein the built-in type extracting and blowing integrated blower (10) further comprises a cover body (600), the housing (400) is provided with a first opening (430), a shape of the cover body (600) is matched with a shape of the first opening (430), the cover body (600) is fixedly assembled at the first opening (430) of the housing (400), and the air pump (100) is disposed within a space enclosed by the cover body (600) and the housing (400).

4. The built-in type extracting and blowing integrated blower (10) according to claim 3, wherein a surface of the cover body (600) is provided with venting grooves (650), and air freely enters and exits from the space enclosed by the cover body (600) and the housing (400) through venting grooves (650).

5. The built-in type extracting and blowing integrated blower (10) according to claim 3, wherein the cover body (600) is provided with fixed teeth (624), the fixed teeth (624) and a reduction gear set (700) are subjected to gear assembling, and when the drive motor (300) drives the reduction gear set (700) to rotate, the reduction gear set (700) moves relative to the fixed teeth (624), thereby driving the air pump (100) connected to the reduction gear set (700) to move.

6. The built-in type extracting and blowing integrated blower (10) according to claim 1, wherein the built-in type extracting and blowing integrated blower (10) further has a bluetooth function, and a user can operate the built-in type extracting and blowing integrated blower (10) to perform air blowing and air extracting through a bluetooth device connected to the built-in type extracting and blowing integrated blower (10).
